(19) United States
(12) Patent Application Publication
(10) Pub. No.: US 2025/0095907 A1
(43) Pub. Date: Mar. 20, 2025

(54) INDUCTOR COMPONENT

(71) Applicant: Murata Manufacturing Co., Ltd., Kyoto-fu (JP)

(72) Inventor: Masaki INUI, Nagaokakyo-shi (JP)

(73) Assignee: Murata Manufacturing Co., Ltd., Kyoto-fu (JP)

(21) Appl. No.: 18/814,150

(22) Filed: Aug. 23, 2024

(30) Foreign Application Priority Data
Sep. 19, 2023 (JP) 2023-151518

(51) Int. Cl. H01F 27/28; H01F 27/02

(52) U.S. Cl. CPC H01F 27/2823; H01F 27/022

(57) ABSTRACT

An inductor component includes an element body having a rectangular parallelepiped shape; an inner wire inside the body and including a coil spirally wound along a coil axial direction; a first outer electrode electrically connected to one end portion of the inner wire and on one of the end surfaces of the body; and a second outer electrode electrically connected to the other end portion of the inner wire and on the other end surface of the body. In a section parallel to the coil axial direction and orthogonal to a direction in which the inner wire extends, the inner wire has four corners, and a part of the inner wire at either end in a direction parallel to the coil axial direction includes the corner that is adjacent to a corner portion of the body and has a shape different from shapes of the remaining three corners.

### CROSS-REFERENCE TO RELATED APPLICATION

This application claims benefit of priority to Japanese Patent Application No. 2023-151518, filed Sep. 19, 2023, the entire content of which is incorporated herein by reference.

### BACKGROUND

### Technical Field

The present disclosure relates to an inductor component.

### Background Art

Japanese Unexamined Patent Application Publication No. 2022-128975 discloses an inductor component including an element body; a coil provided in the element body and spirally wound around an axis; and a first outer electrode and a second outer electrode provided in the element body and electrically connected to the coil. The element body includes a plurality of insulating layers laminated along the axis. The coil includes a plurality of coil wires laminated along the axis and a via wire that extends along the axis and connects the coil wires adjacent in the axial direction. The plurality of coil wires are each wound along a plane and are electrically connected in series to form a spiral. The plurality of coil wires include a first coil wire located at one end in a direction parallel to the axis and connected to the first outer electrode and a second coil wire located at the other end in a direction parallel to the axis and connected to the second outer electrode. The area of an end surface on the one side of the via wire in the direction parallel to the axis is smaller than the area of an end surface on the other side of the via wire in the direction parallel to the axis. The thickness of the second coil wire in the direction parallel to the axis is greater than the thickness of the first coil wire in the direction parallel to the axis.

Japanese Unexamined Patent Application Publication No. 2003-257740 discloses a laminated chip component including a plurality of laminated layers. A conductor layer is laminated in three or more layers to form a conductor path. An outer conductor layer having a width narrower than that of an interlayer conductor layer is formed on each of an upper side and a lower side of the interlayer conductor layer in at least a part of the conductor path.

### SUMMARY

In the inductor component described in Japanese Unexamined Patent Application Publication No. 2022-128975, if the inner diameter of a coil is increased to improve a Q value, there is a possibility that the coil wire inside an element body will be exposed at a ridge portion of the element body. In FIG. 1 of Japanese Unexamined Patent Application Publication No. 2022-128975, although the ridge portion of the element body is illustrated as a right angle, in an actual inductor component, the ridge portion of the element body is curved (made in a round shape R).

In the inductor component described in Japanese Unexamined Patent Application Publication No. 2003-257740, as illustrated in FIG. 3 of Japanese Unexamined Patent Application Publication No. 2003-257740, since all four corners of a section of a conductor path have a stepped shape, the sectional area of the conductor path is small. As a result, a DC resistance (Rdc) is increased. Here, since Q=X/R=X/(Rdc+Rac) (where, Rac is an AC resistance), at low frequencies, Rdc is the main cause of loss, and the Q value at low frequencies decreases.

Accordingly, the present disclosure provides an inductor component that can improve the Q value while suppressing exposure of an inner wire at the ridge portion of an element body.

An inductor component includes an element body having a rectangular parallelepiped shape and including a pair of end surfaces facing each other in a length direction, a top surface and a bottom surface facing each other in a height direction, and a pair of side surfaces facing each other in a width direction; an inner wire provided inside the element body and including a coil spirally wound along a coil axial direction; a first outer electrode electrically connected to one end portion of the inner wire and provided on one of the pair of end surfaces; and a second outer electrode electrically connected to the other end portion of the inner wire and provided on the other of the pair of end surfaces. In a section parallel to the coil axial direction and orthogonal to a direction in which the inner wire extends, the inner wire has four corners, and a part of the inner wire located at either end in a direction parallel to the coil axial direction includes one of the four corners that is adjacent to a corner portion of the element body and has a shape different from shapes of remaining three corners.

According to the present disclosure, it is possible to provide an inductor component that can improve the Q value while suppressing the exposure of an inner wire at the ridge portion of the element body.

### BRIEF DESCRIPTION OF THE DRAWINGS

FIG. 1 is a schematic perspective view illustrating an example of an inductor component according to Embodiment 1 of the present disclosure;

FIG. 2 is a schematic sectional view illustrating an example of a section of the inductor component illustrated in FIG. 1 along the line segment a1-a2;

FIG. 3 is a schematic sectional view illustrating an example of a section of the inductor component illustrated in FIG. 1 along the line segment b1-b2;

FIG. 4 is a schematic sectional view illustrating an example of a corner portion of an element body and the vicinity thereof in the inductor component illustrated in FIG. 2 or 3;

FIG. 5 is a schematic perspective view illustrating an example of an inductor component according to Embodiment 2 of the present disclosure;

FIG. 6 is a schematic sectional view illustrating an example of a section of the inductor component illustrated in FIG. 5 along the line segment a1-a2;

FIG. 7 is a schematic sectional view illustrating an example of a section of the inductor component illustrated in FIG. 5 along the line segment b1-b2;

FIG. 8 is a schematic perspective view illustrating an example of an inductor component according to Embodiment 3 of the present disclosure;

FIG. 9 is a schematic sectional view illustrating an example of a section of the inductor component illustrated in FIG. 8 along the line segment a1-a2;

FIG. 10 is a schematic sectional view illustrating an example of a section of the inductor component illustrated in FIG. 9 along the line segment b1-b2;

FIG. 11 is a schematic sectional view illustrating an example of an inductor component according to Embodiment 4 of the present disclosure; and

FIG. 12 is a schematic sectional view illustrating an example of a corner portion of an element body and the vicinity thereof in the inductor component illustrated in FIG. 11.

### DETAILED DESCRIPTION

Hereinafter, an inductor component of the present disclosure will be described. The present disclosure is not limited to the following configurations and may be modified as appropriate without departing from the gist of the present disclosure. In addition, the present disclosure also includes a combination of a plurality of individual preferred configurations described below.

Each embodiment illustrated below is an example, and it goes without saying that partial replacement or combination of configurations illustrated in different embodiments is possible. In Embodiment 2 and subsequent embodiments, descriptions of matters common to Embodiment 1 will be omitted, and different points will be mainly described. In particular, similar actions and effects due to similar configurations will not be mentioned sequentially for each embodiment.

In the following description, the term “inductor component of the present disclosure” is simply used, in a case where each embodiment is not particularly distinguished.

The drawings illustrated below are schematic views, and the dimensions, aspect ratios, and the like may differ from an actual product.

In this specification, terms denoting relationships between elements (for example, “parallel”, “perpendicular”, “orthogonal”, and the like) and terms denoting shapes of elements are meant not only for a literal and strict aspect but also for substantially equivalent ranges, for example, a range including a difference of approximately several %.

The inductor component includes: an element body having a rectangular parallelepiped shape and including a pair of end surfaces facing each other in a length direction, a top surface and a bottom surface facing each other in a height direction, and a pair of side surfaces facing each other in a width direction; an inner wire provided inside the element body and including a coil spirally wound along a coil axial direction; a first outer electrode electrically connected to one end portion of the inner wire and provided on one of the pair of end surfaces; and a second outer electrode electrically connected to the other end portion of the inner wire and provided on the other of the pair of end surfaces. In a section parallel to the coil axial direction and orthogonal to a direction in which the inner wire extends, the inner wire has four corners, and a part of the inner wire located at either end in a direction parallel to the coil axial direction includes one of the four corners that is adjacent to a corner portion of the element body and has a shape different from shapes of remaining three corners.

### Embodiment 1

An example of an inductor component according to the present disclosure will be described below as an inductor component according to Embodiment 1 of the present disclosure.

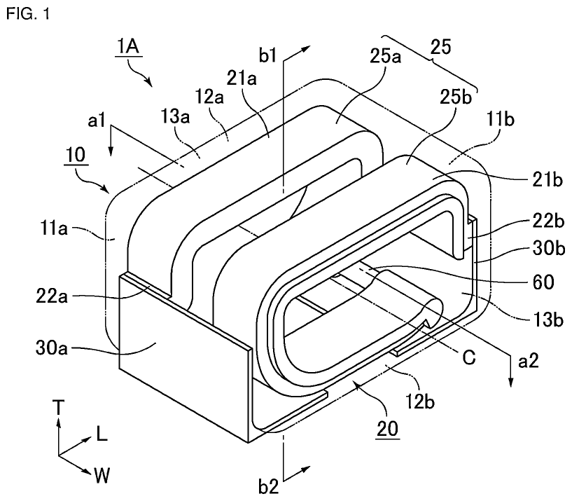

FIG. 1 is a schematic perspective view illustrating an example of the inductor component according to Embodiment 1 of the present disclosure.

An inductor component 1A illustrated in FIG. 1 includes an element body 10, an inner wire 25 including a coil 20, a first outer electrode 30a, and a second outer electrode 30b.

In this specification, the length direction, the height direction, and the width direction are the directions defined by L, T, and W, respectively, as illustrated in FIG. 1 and the like. Here, the length direction L, the height direction T, and the width direction W are orthogonal to each other.

As illustrated in FIG. 1, in the inductor component 1A, the surfaces of the element body 10 include a pair of end surfaces 11a and 11b facing each other in the length direction L, a top surface 12a and a bottom surface 12b facing each other in the height direction T, and a pair of side surfaces 13a and 13b facing each other in the width direction W. In the inductor component 1A, the width direction W is parallel to the coil axial direction of the coil 20. That is, in the inductor component 1A, the surfaces of the element body 10 include the bottom surface 12b parallel to the coil axial direction and the top surface 12a facing the bottom surface 12b in the height direction T orthogonal to the coil axial direction.

In the inductor component 1A, the bottom surface 12b of the element body 10 is a mounting surface. More specifically, the bottom surface 12b of the element body 10 is a mounting surface that faces an object on which the inductor component 1A is to be mounted (for example, substrate) when the inductor component 1A is mounted. Therefore, in the inductor component 1A, the mounting surface of the element body 10, that is, the bottom surface 12b of the element body 10 is parallel to the coil axial direction.

At least one of the surfaces of the element body 10, that is, at least one of the end surface 11a, the end surface 11b, the top surface 12a, the bottom surface 12b, the side surface 13a, and the side surface 13b, may be marked for easy identification of each surface.

The end surface 11a and the end surface 11b of the element body 10 need not be strictly orthogonal to the length direction L. In addition, the top surface 12a and the bottom surface 12b of the element body 10 need not be strictly orthogonal to the height direction T. Furthermore, the side surface 13a and the side surface 13b of the element body 10 need not be strictly orthogonal to the width direction W.

As illustrated in FIG. 1, the element body 10 has a rectangular parallelepiped shape.

In this specification, the rectangular parallelepiped shape may be any shape that can be considered to be substantially a rectangular parallelepiped shape and includes, for example, a substantially rectangular parallelepiped shape with rounded corner portions and rounded ridge portions as described later.

In the element body 10, it is preferable that corner portions and ridge portions are rounded. When the element body 10 is viewed three-dimensionally, the corner portion of the element body 10 is a portion where three surfaces of the element body 10 intersect, and when the element body 10 is viewed in section as described later, the corner portion of the element body 10 is a portion where two sides of the element body 10 intersect. The ridge portion of the element body 10 is a portion where two surfaces of the element body 10 intersect.

The element body 10 includes an insulating layer, and the element body 10 is made up of a plurality of insulating layers laminated in the coil axial direction, but the insulating layers are not illustrated in FIG. 1 because the boundaries between these layers are not clearly visible in reality.

Examples of the insulating material constituting the insulating layer include glass materials whose main component is borosilicate glass, ceramic materials, organic materials such as epoxy resins, fluororesins, and polymer resins, and composite materials such as glass epoxy resins. As the insulating material, a material having a low dielectric constant and low dielectric loss is particularly preferable.

The insulating materials constituting the plurality of the insulating layers may be the same as each other, may be different from each other, or may be partially different.

The dimensions of the plurality of the insulating layers in the coil axial direction may be the same as each other, may be different from each other, or may be partially different.

As illustrated in FIG. 1, the coil 20 is provided inside the element body 10 and is spirally wound along the coil axial direction.

The coil axial direction of the coil 20 is the direction where a coil axis C of the coil 20 extends, and is parallel to the bottom surface 12b, which is the mounting surface of the element body 10, as described above.

The coil 20 is spirally wound such that at least a part of the inner wire 25 provided inside the element body 10 is stacked in the coil axial direction and electrically connected to each other.

The inner wire 25 includes a plurality of inner wires, specifically, a first inner wire 25a and a second inner wire 25b. That is, in the present embodiment, the number of the laminated layers of the inner wires 25 is two.

The first inner wire 25a is an inner wire located at one end of a plurality of inner wires 25 in a direction parallel to the coil axial direction and is located at the outermost position of the inner wires 25 on the side surface 13a side of the element body 10 in the coil axial direction.

The first inner wire 25a is connected to the first outer electrode 30a.

The second inner wire 25b is the other inner wire located at the other end in the direction parallel to the coil axial direction among the plurality of inner wires 25, and is located at the outermost position of the inner wires 25 on the side surface 13b side of the element body 10 in the coil axial direction.

The second inner wire 25b is connected to the second outer electrode 30b.

As in Embodiment 2 described below, at least one inner wire may exist between the first inner wire 25a and the second inner wire 25b in the coil axial direction.

The first inner wire 25a includes a first coil wire 21a and a first extended wire 22a.

The second inner wire 25b includes a second coil wire 21b and a second extended wire 22b.

The coil 20 is formed by at least a part of the inner wires 25, more specifically, a plurality of coil wires including the first coil wire 21a and the second coil wire 21b, which are stacked and electrically connected in the coil axial direction. That is, the first coil wire 21a and the second coil wire 21b each constitute the coil 20.

The first coil wire 21a may have a single-layer structure, but preferably has a multi-layer structure from the viewpoint of ease of manufacture.

The second coil wire 21b may have a single-layer structure, but preferably has a multi-layer structure from the viewpoint of ease of manufacture.

At least one coil wire may exist between the first coil wire 21a and the second coil wire 21b in the coil axial direction.

Examples of the conductive material constituting the coil wire include Ag, Au, Cu, Pd, Ni, Al, and alloys containing at least one of these metals.

The conductive materials constituting the plurality of the coil wires may be the same as each other, may be different from each other, or may be partially different.

The dimensions of the plurality of the coil wires in the coil axial direction may be the same as each other, may be different from each other, or may be partially different.

The dimensions of the plurality of the coil wires in the direction orthogonal to the direction where the coil wires extend when viewed in the coil axial direction, that is, the widths when viewed in the coil axial direction may be the same as each other, may be different from each other, or may be partially different.

Among the plurality of coil wires, coil wires that are adjacent to each other in the coil axial direction may be electrically connected through a connection conductor (via) that penetrates an insulating layer between the adjacent coil wires in the coil axial direction. In the example illustrated in FIG. 1, the coil 20 includes the first coil wire 21a and the second coil wire 21b, which are stacked in the coil axial direction and are electrically connected through a connection conductor 60.

The connection conductor may have a single-layer structure or a multi-layer structure.

Examples of the conductive material constituting the connection conductor include Ag, Au, Cu, Pd, Ni, Al, and alloys containing at least one of these metals.

When viewed in the coil axial direction, the coil 20 may have a shape including only a straight portion, a shape including only a curved portion, or a shape including a straight portion and a curved portion. For example, when viewed from the coil axial direction, the coil 20 may have a circular shape, an elliptical shape, or a polygonal shape.

As illustrated in FIG. 1, the first outer electrode 30a is electrically connected to one end portion of the inner wire 25 (here, the first inner wire 25a). More specifically, as illustrated in FIG. 1, the first coil wire 21a constituting the coil 20 is electrically connected to the first outer electrode 30a with the first extended wire 22a interposed therebetween. That is, the first extended wire 22a connects the first coil wire 21a and the first outer electrode 30a.

The first extended wire 22a may have a single-layer structure or a multi-layer structure.

As illustrated in FIG. 1, the second outer electrode 30b is electrically connected to the other end portion of the inner wire 25 (here, the second inner wire 25b). More specifically, as illustrated in FIG. 1, the second coil wire 21b constituting the coil 20 is electrically connected to the second outer electrode 30b with the second extended wire 22b interposed therebetween. That is, the second extended wire 22b connects the second coil wire 21b and the second outer electrode 30b.

The second extended wire 22b may have a single-layer structure or a multi-layer structure.

Examples of the conductive material constituting the extended wire include Ag, Au, Cu, Pd, Ni, Al, and alloys containing at least one of these metals.

The conductive materials constituting the first extended wire 22a and the second extended wire 22b may be the same or different from each other.

In the present specification, a wire that does not overlap the winding portion of the coil (protruding from the winding portion of the coil) when viewed from the coil axial direction is referred to as an extended wire (for example, the example illustrated in FIG. 1).

As illustrated in FIG. 1, the first outer electrode 30a is provided on the end surface 11a of the element body 10. That is, in the example illustrated in FIG. 1, the first outer electrode 30a is exposed at least on the end surface 11a of the element body 10.

As illustrated in FIG. 1, the first outer electrode 30a is preferably exposed on the bottom surface 12b of the element body 10.

In the example illustrated in FIG. 1, the first outer electrode 30a extends from a part of the end surface 11a of the element body 10 to a part of the bottom surface 12b. That is, in the example illustrated in FIG. 1, the first outer electrode 30a is exposed not only on a part of the end surface 11a of the element body 10 but also on a part of the bottom surface 12b of the element body 10.

The first outer electrode 30a may be exposed only on the end surface 11a of the element body 10.

As illustrated in FIG. 1, the second outer electrode 30b is provided on the end surface 11b of the element body 10. That is, in the example illustrated in FIG. 1, the second outer electrode 30b is exposed at least on the end surface 11b of the element body 10.

As illustrated in FIG. 1, the second outer electrode 30b is preferably exposed on the bottom surface 12b of the element body 10.

In the example illustrated in FIG. 1, the second outer electrode 30b extends from a part of the end surface 11b of the element body 10 to a part of the bottom surface 12b. That is, in the example illustrated in FIG. 1, the second outer electrode 30b is exposed not only on a part of the end surface 11b of the element body 10 but also on a part of the bottom surface 12b of the element body 10.

The second outer electrode 30b may be exposed only on the end surface 11b of the element body 10.

As described above, the first outer electrode 30a and the second outer electrode 30b are provided so as to be separated from each other in a direction orthogonal to the coil axial direction (here, the length direction L).

In addition, when each of the first outer electrode 30a and the second outer electrode 30b is exposed on the bottom surface 12b of the element body 10, which is a mounting surface, the mountability of the inductor component 1A is likely to be improved.

In the example illustrated in FIG. 1, the dimension of the first outer electrode 30a in the coil axial direction is smaller than the dimension of the element body 10 in the coil axial direction.

The dimension of the first outer electrode 30a in the coil axial direction may be the same as the dimension of the element body 10 in the coil axial direction.

In the example illustrated in FIG. 1, the dimension of the second outer electrode 30b in the coil axial direction is smaller than the dimension of the element body 10 in the coil axial direction.

The dimension of the second outer electrode 30b in the coil axial direction may be the same as the dimension of the element body 10 in the coil axial direction.

Examples of conductive materials constituting the outer electrode include Ag, Au, Cu, Pd, Ni, Al, and alloys containing at least one of these metals.

The conductive materials constituting the first outer electrode 30a and the second outer electrode 30b may be the same as or different from each other.

The first outer electrode 30a may have a single-layer structure or a multi-layer structure.

The first outer electrode 30a may have, in order from the coil 20 side, a base electrode containing the above-described conductive material (for example, Ag), a Ni-plated electrode, and an Sn-plated electrode. In this case, in the first outer electrode 30a, the base electrode may form an integral surface with the surface of the element body 10 (in FIG. 1, the end surface 11a and the bottom surface 12b of the element body 10), and the Ni-plated electrode and the Sn-plated electrode may protrude from the surface of the element body 10 (in FIG. 1, the end surface 11a and the bottom surface 12b of the element body 10) so as to cover the base electrode.

The second outer electrode 30b may have a single-layer structure or may have a multi-layer structure.

The second outer electrode 30b may have, in order from the coil 20 side, a base electrode containing the above-described conductive material (for example, Ag), a Ni-plated electrode, and an Sn-plated electrode. In this case, in the second outer electrode 30b, the base electrode may form an integral surface with the surface of the element body 10 (in FIG. 1, the end surface 11b and the bottom surface 12b of the element body 10), and the Ni-plated electrode and the Sn-plated electrode may protrude from the surface of the element body 10 (in FIG. 1, the end surface 11b and the bottom surface 12b of the element body 10) so as to cover the base electrode.

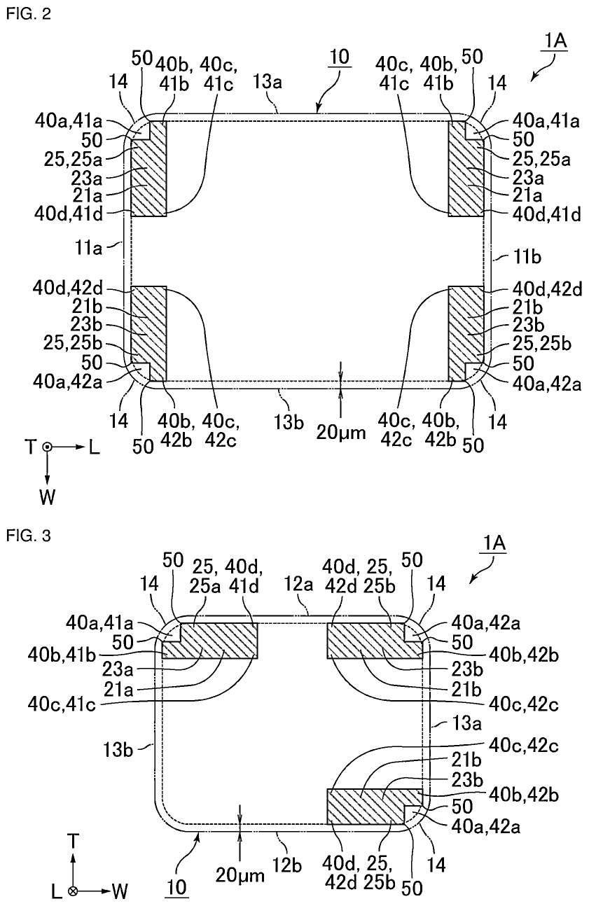

FIG. 2 is a schematic sectional view illustrating an example of a section of the inductor component illustrated in FIG. 1 along the line segment a1-a2. FIG. 3 is a schematic sectional view illustrating an example of a section of the inductor component illustrated in FIG. 1 along the line segment b1-b2. FIGS. 2 and 3 each illustrate a section parallel to the coil axial direction and orthogonal to the direction in which the inner wire 25 extends. Hereinafter, such a section will be simply referred to as a “vertical section.” More specifically, FIG. 2 illustrates a vertical section along the length direction L and the width direction W of the inductor component 1A illustrated in FIG. 1, that is, a vertical section including the first coil wire 21a and the second coil wire 21b in an LW plane. FIG. 3 illustrates a vertical section along the width direction W and the height direction T of the inductor component 1A illustrated in FIG. 1, that is, a vertical section including the first coil wire 21a and the second coil wire 21b in a WT plane.

As illustrated in FIG. 2, in the vertical section (LW plane), each inner wire 25 has four corners 40a to 40d, and in the inner wire 25 located at either end in the direction parallel to the coil axial direction, the shape of the corner 40a adjacent to the corner portion 14 of the element body 10 is different from the shapes of the remaining three corners 40b to 40d.

As a result, it is possible to form the shape of the corner 40a into a shape that is difficult to be exposed from the corner portion 14 of the element body 10 (for example, a notch shape illustrated in FIG. 2 or the like) and to form the shapes of the remaining three corners 40b to 40d into shapes in which the sectional area of the inner wire 25 can be increased (for example, a right angled shape illustrated in FIG. 2 or the like). That is, Rdc can be reduced. Therefore, it is possible to improve the Q value of the inductor component 1A, particularly, the Q value at low frequencies, while suppressing the exposure of the inner wire 25 located at the end to the ridge portion of the element body 10, specifically, the ridge portion including the corner portion 14.

In the example illustrated in FIG. 2, in the vertical section (LW plane), the first coil wire 21a of the first inner wire 25a located at one end in the direction parallel to the coil axial direction has two wire portions 23a adjacent to the two corner portions 14 of the element body 10, respectively, and in each wire portion 23a, among the four corners 41a to 41d, the shape of the corner 41a adjacent to the corner portion 14 of the element body 10 is different from the shape of the remaining three corners 41b to 41d.

In the example illustrated in FIG. 2, in the vertical section (LW plane), the second coil wire 21b of the second inner wire 25b located at the other end in the direction parallel to the coil axial direction has two wire portions 23b adjacent to the two corner portions 14 of the element body 10, respectively, and in each wire portion 23b, among the four corners 42a to 42d, the shape of the corner 42a adjacent to the corner portion 14 of the element body 10 is different from the shape of the remaining three corners 42b to 42d.

In addition, as illustrated in FIG. 3, in the vertical section (WT plane), each inner wire 25 has the corners 40a to 40d, and in the inner wire 25 located at either end in the direction parallel to the coil axial direction, the shape of the corner 40a adjacent to the corner portion 14 of the element body 10 is different from the shapes of the remaining three corners 40b to 40d.

As a result, as in the case illustrated in FIG. 2, it is possible to form the shape of the corner 40a into a shape that is difficult to be exposed from the corner portion 14 of the element body 10 (for example, a notch shape illustrated in FIG. 3 or the like) and to form the shapes of the remaining three corners 40b to 40d into shapes in which the sectional area of the inner wire 25 can be increased (for example, a right-angled shape illustrated in FIG. 3 or the like). That is, Rdc can be reduced. Therefore, it is possible to improve the Q value of the inductor component 1A, particularly, the Q value at low frequencies, while suppressing the exposure of the inner wire 25 located at the end to the ridge portion of the element body 10, specifically, the ridge portion including the corner portion 14.

In the example illustrated in FIG. 3, in the vertical section (WT plane), the first coil wire 21a of the first inner wire 25a located at one end in the direction parallel to the coil axial direction has one wire portion 23a adjacent to one corner portion 14 of the element body 10, and in the wire portion 23a, among the four corners 41a to 41d, the shape of the corner 41a adjacent to the corner portion 14 of the element body 10 is different from the shape of the remaining three corners 41b to 41d.

In the example illustrated in FIG. 3, in the vertical section (WT plane), the second coil wire 21b of the second inner wire 25b located at the other end in the direction parallel to the coil axial direction has two wire portions 23b adjacent to the two corner portions 14 of the element body 10, respectively, and in each wire portion 23b, among the four corners 42a to 42d, the shape of the corner 42a adjacent to the corner portion 14 of the element body 10 is different from the shape of the remaining three corners 42b to 42d.

As illustrated in FIGS. 2 and 3, it is preferable that the shape of the corner 40a adjacent to the corner portion 14 of the element body 10 is different from the shape of the remaining three corners 40b to 40d in the respective vertical sections of the LW plane and the WT plane, but this relationship may be satisfied only in the vertical section of either the LW plane or the WT plane.

In the present embodiment, it is preferable that this relationship is satisfied at least in the WT plane.

However, the inductor component of the present disclosure only needs to satisfy this relationship in at least one vertical section.

In the vertical section, each inner wire 25 has four corners 40a to 40d, the corner 40a adjacent to the corner portion 14 is disposed at a position facing the corner 40c, and the corner 40b is disposed at a position facing the corner 40d. The corner 40a is disposed near the corner portion 14 of the element body 10. The corners 40b and 40d are disposed near the flat portion of the element body 10. The corner 40c is disposed closest to the center of the element body 10 among the four corners 40a to 40d.

As illustrated in FIGS. 2 and 3, in the vertical section, the shape of the corner 40a adjacent to the corner portion 14 of the element body 10 may be a notch shape.

In the present specification, the “notch shape” is a shape in which one recessed portion is provided toward the center of the inner wire in the vertical section, and the notch shape has a stepped shape with one step as illustrated in FIGS. 2 and 3.

In the vertical section, the shapes of the remaining three corners 40b to 40d are not particularly limited but may be a right-angled shape as illustrated in FIGS. 2 and 3.

Here, the “right-angled shape” may be a round shape (R) at the apex of the corner.

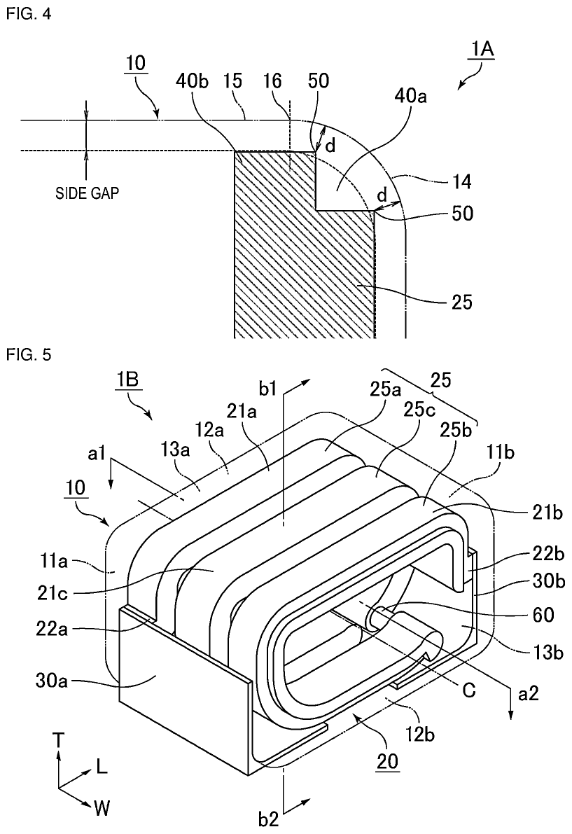

FIG. 4 is a schematic sectional view illustrating an example of a corner portion of the element body and the vicinity thereof in the inductor component illustrated in FIG. 2 or 3. In FIG. 4, the broken line indicates the position of the side gap of a product. That is, the position indicates a position offset from the outer shape of the element body 10 by the side gap. On the other hand, the broken lines in FIGS. 2 and 3 indicate positions offset by 20 μm from the outer shape of the element body 10.

In the vertical section, the corner 40a of the inner wire 25, adjacent to the corner portion 14 of the element body 10, preferably has at least one corner portion 50, and more preferably has at least two corner portions 50 whose distance d from the corner portion 14 of the element body 10 (see FIG. 4) is equal to or less than the side gap of the product (see FIG. 4) or equal to or less than 20 μm (see FIGS. 2 and 3). As a result, since the sectional area of the inner wire 25 can be increased, the Q value of the inductor component 1A can be further improved.

In the example illustrated in FIG. 2, in the vertical section (LW plane), there are the corner portions 50 of the inner wires 25 whose distance from the corner portion 14 of the element body 10 is 20 μm or less, at 2 locations×4 corners (8 locations in total).

In the example illustrated in FIG. 3, in the vertical section (WT plane), there are the corner portions 50 of the inner wires 25 whose distance from the corner portion 14 of the element body 10 is equal to or less than 20 μm at 2 locations×3 corners (6 locations in total).

In the example illustrated in FIG. 4, in the vertical section, for each corner portion 14, there are two corner portions 50 of the inner wire 25 protruding from the side gap.

In the present specification, the side gap of the product is the distance from the inner wire to the surface (plane only) of the element body, regardless of the length direction L, the width direction W, or the height direction T. More specifically, as illustrated in FIG. 4, in an image of a vertical section captured by a scanning electron microscope or the like, a straight line passing through the average position of the flat portion 15 of the element body 10 connected to the curve of the corner portion 14 via a connecting portion 16, a straight line parallel to this straight line and passing through the average position of the inner wire 25 facing the flat portion 15 are calculated, and the distance between these two straight lines is measured and defined as the side gap of the product.

The lower limit of the side gap is considered to be at least about 2 to 3 μm, preferably about 5 μm, from the viewpoints of impact resistance, plating resistance, and pressure resistance. In addition, even if the side gap is designed to be about 20 μm, if the processing variation is about 3 μm, the minimum side gap for Cpk=1.67 will be 5 μm.

From such a viewpoint, the distance d between the corner portion 14 of the element body 10 and the corner portion 50 of the corner 40a adjacent to the corner portion 14 is preferably 2 μm or more, more preferably 3 μm or more, and even more preferably 5 μm or more.

The inductor component 1A is manufactured by, for example, a photolithography method. That is, first, an insulating paste layer, a coil conductor layer, a connection conductor layer, and an outer conductor layer are formed to have a predetermined stacked structure to produce a mother multilayer body by repeating patterning of the insulating paste layer by the photolithography method and patterning of the conductor layer by the photolithography method.

The patterning of the insulating paste layer can be performed, for example, by the following method. First, an insulating paste layer is formed by applying a photosensitive insulating paste containing a glass material mainly composed of borosilicate glass or the like by screen printing, and the like, and the formed insulating paste layer is irradiated with ultraviolet rays or the like through a photomask and then developed with an alkaline solution or the like to form via holes, openings, and the like in the insulating paste layer.

The patterning of the conductor layer can be performed, for example, by the following method. First, a conductive paste layer is formed by applying a photosensitive conductive paste mainly composed of Ag or the like by screen printing or the like, and the formed conductive paste layer is irradiated with ultraviolet rays or the like through a photomask and then developed with an alkaline solution or the like to form a coil conductor layer, an outer conductor layer, an extended conductor layer connected to the coil conductor layer and the outer conductor layer, and the like.

At this time, by forming (laminating) a plurality of conductor patterns in multiple stages while changing the outer shape of the pattern, in the vertical section, the corner 40c of the inner wire 25 located at either end in the direction parallel to the coil axial direction can be formed into a notch shape or a stepped shape, which will be described later.

Instead of exposure using a photomask, for example, DI exposure (also referred to as direct image exposure or direct writing) without using a photomask may be performed.

A method of forming conductor patterns of the coil conductor layer, the extended conductor layer, the connection conductor layer, and the outer conductor layer is not limited to the photolithography method described above, and may be, for example, a method of printing and laminating a conductive paste using a screen printing plate having openings in the shape of the conductor pattern, a method of forming a conductor film by a sputtering method, a vapor deposition method, a method of pressure-bonding a foil, or the like, and then etching the conductor film so as to have the shape of a conductor pattern, or a method of forming a negative pattern by a semi-additive method, forming a plating film, and then removing unnecessary portions of the plating film by etching or the like so as to form the shape of a conductor pattern.

The method of forming the conductor patterns in multiple stages is not particularly limited, and may be, for example, a method of repeatedly superimposing the conductor pattern by repeating the step using the photolithography method as described above, a method of repeatedly superimposing conductor patterns formed by a semi-additive method, a method of superimposing conductor patterns formed by a semi-additive method and conductor patterns formed by etching a plating film grown separately by plating in random order, or a method of further plating and growing a plating film formed by a semi-additive method.

The conductive material constituting the conductor patterns of the coil conductor layer, the extended conductor layer, the connection conductor layer, and the outer conductor layer is not limited to the above-described photosensitive conductive paste containing Ag or the like as a main metal component, and may be, for example, a conductor containing a metal such as Ag, Au, and Cu formed by a sputtering method, a vapor deposition method, a method of pressure-bonding a foil, a plating method, or the like.

A method of forming the insulating paste layer is not limited to the photolithography method described above, and may be, for example, a method of pressure-bonding a sheet made of an insulating material, or a method of spin-coating an insulating material, or a method of spray-coating an insulating material.

The method of forming the insulating paste layer provided with the via hole and the opening is not limited to the photolithography method described above, and may be, for example, a method in which an insulating film is formed by a method such as pressure-bonding a sheet made of an insulating material, spin-coating an insulating material, or spray-coating an insulating material, and then the via hole and the opening are provided by subjecting the insulating film to laser processing, drill processing, or the like.

The insulating material that constitutes the insulating paste layer is not limited to the above-described glass materials containing borosilicate glass as a main component, and may be, for example, ceramic materials, organic materials such as epoxy resins, fluororesins, and polymer resins, composite materials such as glass epoxy resins, or the like. As the insulating material, a material having a low dielectric constant and low dielectric loss is particularly preferable.

Thereafter, the mother multilayer body is cut with a dicing machine or the like to separate into a plurality of unfired multilayer bodies.

The unfired multilayer body includes an insulating paste multilayer portion in which the insulating paste layers are laminated, a coil conductor multilayer portion in which the coil conductor layers are laminated such that adjacent coil conductor layers are electrically connected to each other with a connection conductor layer interposed therebetween, and an outer conductor multilayer portion in which the outer conductor layers are laminated.

When being separated into the unfired multilayer bodies, the outer conductor multilayer portions are exposed at two locations on at least the side surfaces of the insulating paste multilayer portion included in the cut surface of the unfired multilayer body.

Next, a multilayer body is produced by firing the unfired multilayer body.

When the unfired multilayer body is fired, the insulating paste layer becomes the insulating layer, and the insulating paste multilayer portion becomes the element body 10. In addition, when the unfired multilayer body is fired, the coil conductor layer becomes the coil wire, so that the coil conductor multilayer portion becomes the coil 20. Furthermore, when the unfired multilayer body is fired, one of the two outer conductor multilayer portions becomes a part of the first outer electrode 30a and the other becomes a part of the second outer electrode 30b.

Next, the corner portions and ridge portions of the element body 10 may be rounded by, for example, barrel polishing the obtained multilayer body.

Finally, using the two outer conductor multilayer portions after firing as base electrodes, a Ni-plated electrode and an Sn-plated electrode are sequentially formed on the surface of each of the base electrodes by plating treatment. Each of the thicknesses of the Ni-plated electrode and the Sn-plated electrode is, for example, 2 μm or more and 10 μm or less (i.e., from 2 μm to 10 μm).

In this manner, the first outer electrode 30a and the second outer electrode 30b, which have the base electrode, the Ni-plated electrode, and the Sn-plated electrode in order from the surface side of the element body 10, are formed. In this case, in the first outer electrode 30a, the base electrode may form an integral surface with the surface of the element body 10 (in FIG. 1, the end surface 11a and the bottom surface 12b of the element body 10), and the Ni-plated electrode and the Sn-plated electrode may protrude from the surface of the element body 10 (in FIG. 1, the end surface 11a and the bottom surface 12b of the element body 10) so as to cover the base electrode. In addition, in the second outer electrode 30b, the base electrode may form an integral surface with the surface of the element body 10 (in FIG. 1, the end surface 11b and the bottom surface 12b of the element body 10), and the Ni-plated electrode and the Sn-plated electrode may protrude from the surface of the element body 10 (in FIG. 1, the end surface 11b and the bottom surface 12b of the element body 10) so as to cover the base electrode.

A method of forming the outer electrodes is not limited to a method of plating the outer conductor multilayer portion exposed on the cut surface of the unfired multilayer body (at least the side surface of the insulating paste multilayer portion) as described above, and may be, for example, a method of exposing the outer conductor multilayer portion on the cut surface of the unfired multilayer body (at least the side surface of the insulating paste multilayer portion) as described above, then immersing (dipping) the exposed portion of the outer conductor multilayer portion in a conductive paste or forming a film of the conductive paste on the exposed portion of the outer conductor multilayer portion by a sputtering method, and then plating the exposed portion.

As described above, the inductor component 1A is manufactured.

The inductor component 1A is manufactured with a size of 0402 (0.4 mm×0.2 mm×0.2 mm), for example. The size of inductor component 1A is not limited to 0402 (0.4 mm×0.2 mm×0.2 mm) size.

### Embodiment 2

In the inductor component according to Embodiment 2 of the present disclosure, the number of the laminated layers of the inner wires is three. The inductor component according to Embodiment 2 of the present disclosure is the same as the inductor component according to Embodiment 1 of the present disclosure except for this point.

FIG. 5 is a schematic perspective view illustrating an example of an inductor component according to Embodiment 2 of the present disclosure.

In the inductor component 1B illustrated in FIG. 5, the inner wire 25 includes a third inner wire 25c in addition to the first inner wire 25a and the second inner wire 25b. That is, the inner wire 25 includes the first inner wire 25a located at one end, the second inner wire 25b located at the other end, and the third inner wire 25c located between the first inner wire 25a and the second inner wire 25b, in the direction parallel to the coil axial direction.

The third inner wire 25c is the inner wire 25 that is not located at the end in the direction parallel to the coil axial direction, and is located at the center of the inner wire 25 in the coil axial direction.

The third inner wire 25c includes a third coil wire 21c between the first coil wire 21a and the second coil wire 21b in the coil axial direction.

In the present embodiment, the coil 20 is formed by electrically connecting a plurality of coil wires, including the first coil wire 21a, the second coil wire 21b, and the third coil wire 21c, which are stacked in the coil axial direction. That is, the first coil wire 21a, the second coil wire 21b, and the third coil wire 21c each constitute the coil 20.

The third coil wire 21c may have a single-layer structure or a multi-layer structure.

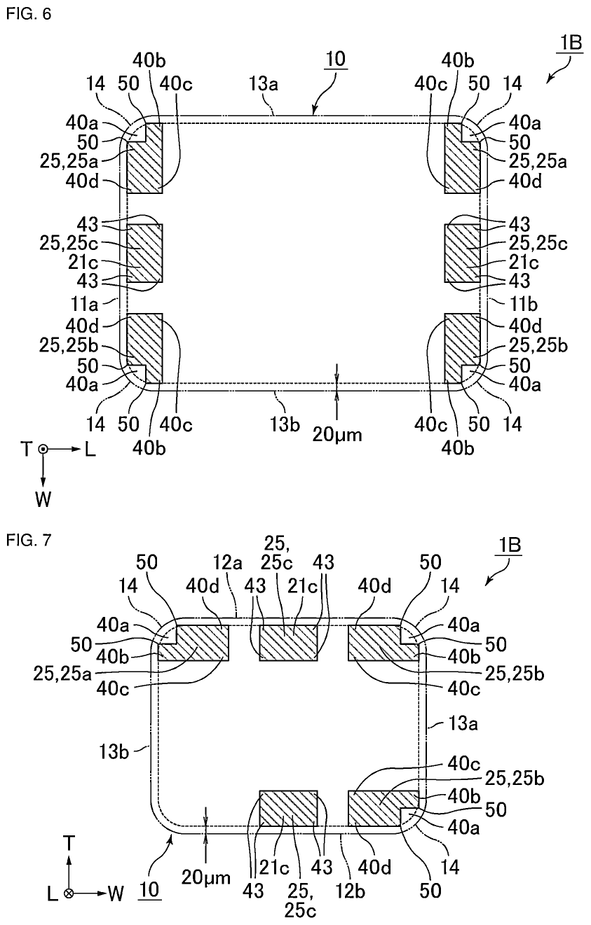

FIG. 6 is a schematic sectional view illustrating an example of a section of the inductor component illustrated in FIG. 5 along the line segment a1-a2. FIG. 7 is a schematic sectional view illustrating an example of a section of the inductor component illustrated in FIG. 5 along the line segment b1-b2. FIGS. 6 and 7 each illustrate a vertical section. More specifically, FIG. 6 illustrates a vertical section of the inductor component 1B illustrated in FIG. 5 along the length direction L and the width direction W, that is, a vertical section including the first coil wire 21a, the second coil wire 21b, and the third coil wire 21c in the LW plane. FIG. 7 illustrates a vertical section of the inductor component 1B illustrated in FIG. 5 along the width direction W and the height direction T, that is, a vertical section including the first coil wire 21a, the second coil wire 21b, and the third coil wire 21c in the WT plane.

In addition, the broken line in FIGS. 6 and 7 indicates a position offset from the outer shape of the element body 10 by 20 μm.

As illustrated in FIGS. 6 and 7, as in Embodiment 1, in the vertical section, the inner wire 25 located at either end in the direction parallel to the coil axial direction has a notch shape, and the shape of the corner 40a adjacent to the corner portion 14 of the element body 10 is different from the shapes of the remaining three corners 40b to 40d.

On the other hand, in the present embodiment, the shape of the third inner wire 25c, which is the inner wire 25 not located at the end in the direction parallel to the coil axial direction, particularly, the corner 43 of the third coil wire 21c, does not have a notch shape, a stepped shape, or a curved shape, which will be described later, in the vertical section. Therefore, it is possible to form the shape of the third inner wire 25c into a shape (for example, a rectangular shape) whose sectional area can be increased. Therefore, it is possible to further improve the Q value of the inductor component 1A.

Since there is the third inner wire 25c at a position facing the flat portion of the element body 10, the third inner wire 25c is not exposed from the corner portion 14 of the element body 10 even in a case of not having a notch shape or the like.

The third inner wire 25c has four corners 43, and all the corners 43 of the third inner wire 25c have the same shape as each other, for example, a right-angled shape illustrated in FIGS. 6 and 7.

Also in the present embodiment, as in Embodiment 1, in the vertical section, the corner 40a of the inner wire 25 located at the end, adjacent to the corner portion 14 of the element body 10, preferably has at least one corner portion 50, and more preferably has at least two corner portions 50 whose distance d from the corner portion 14 of the element body 10 is equal to or less than the side gap of the product or equal to or less than 20 μm (see FIGS. 6 and 7).

In the example illustrated in FIG. 6, in the vertical section (LW plane), there are the corner portions 50 of the inner wires 25 whose distance from the corner portion 14 of the element body 10 is 20 μm or less at 2 locations×4 corners (8 locations in total).

In the example illustrated in FIG. 7, in the vertical section (WT plane), there are the corner portions 50 of the inner wires 25 whose distance from the corner portion 14 of the element body 10 is equal to or less than 20 μm at 2 locations×3 corners (6 locations in total).

### Embodiment 3

In the inductor component of Embodiment 3 of the present disclosure, the coil axial direction of the coil is parallel to the height direction T, and the inner wire located at either end in the direction parallel to the coil axial direction includes an inner wire having a stepped shape of the corner adjacent to the corner portion of the element body in the vertical section. The inductor component according to Embodiment 3 of the present disclosure is the same as the inductor component according to Embodiment 2 of the present disclosure except for this point.

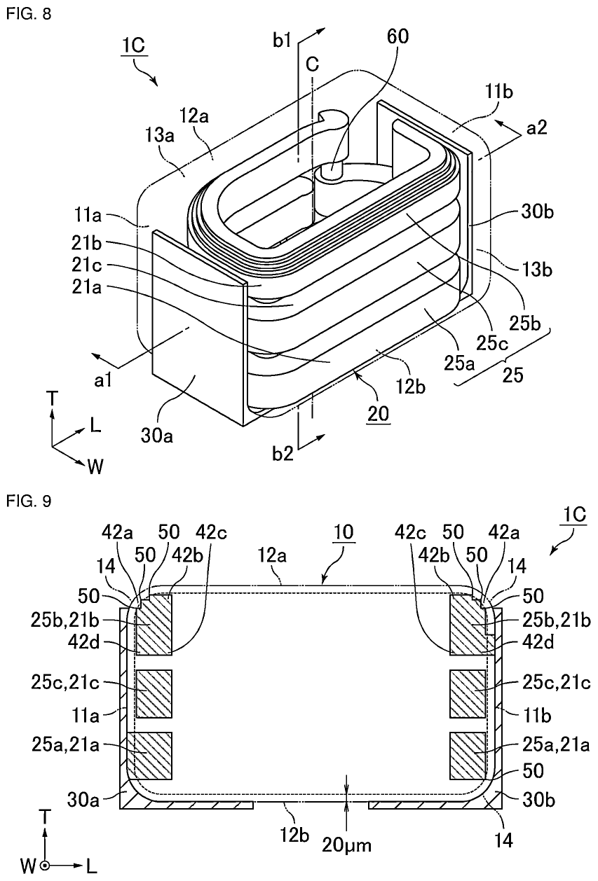

FIG. 8 is a schematic perspective view illustrating an example of an inductor component according to Embodiment 3 of the present disclosure.

In an inductor component 1C illustrated in FIG. 8, the height direction Tis parallel to the coil axial direction of the coil 20. That is, in the inductor component 1C, the surface of the element body 10 includes the bottom surface 12b that is orthogonal to the coil axial direction, and the top surface 12a that faces the bottom surface 12b in the height direction T that is parallel to the coil axial direction.

In the inductor component 1C as well, the bottom surface 12b of the element body 10 is a mounting surface. Therefore, in the inductor component 1C, the mounting surface of the element body 10, that is, the bottom surface 12b of the element body 10 is orthogonal to the coil axial direction.

The coil axial direction of the coil 20 is a direction in which the coil axis C of the coil 20 extends, and is orthogonal to the bottom surface 12b, which is the mounting surface of the element body 10, as described above.

In the inductor component 1C illustrated in FIG. 8, the inner wire 25 includes the first inner wire 25a, the second inner wire 25b, and the third inner wire 25c. That is, in the present embodiment, the number of the laminated layers of the inner wires 25 is 3. The inner wire 25 includes the first inner wire 25a located at one end, the second inner wire 25b located at the other end, and the third inner wire 25c located between the first inner wire 25a and the second inner wire 25b, in the direction parallel to the coil axial direction.

The first inner wire 25a is the inner wire 25 among the plurality of inner wires 25, which is located at one end in a direction parallel to the coil axial direction, and is located at the outermost position of the inner wires 25 on the bottom surface 12b side of the element body 10 in the coil axial direction.

The first inner wire 25a is connected to the first outer electrode 30a.

The second inner wire 25b is the inner wire 25 among the plurality of inner wires 25, which is located at the other end in a direction parallel to the coil axial direction, and is located at the outermost position of the inner wires 25 on the top surface 12a side of the element body 10 in the coil axial direction.

The second inner wire 25b is connected to the second outer electrode 30b.

The third inner wire 25c is the inner wire 25 that is not located at the end in the direction parallel to the coil axial direction, and is located at the center of the inner wire 25 in the coil axial direction.

In the present embodiment as well, the coil 20 is formed by electrically connecting a plurality of coil wires, including the first coil wire 21a, the second coil wire 21b, and the third coil wire 21c, which are stacked in the coil axial direction. That is, the first coil wire 21a, the second coil wire 21b, and the third coil wire 21c each constitute the coil 20.

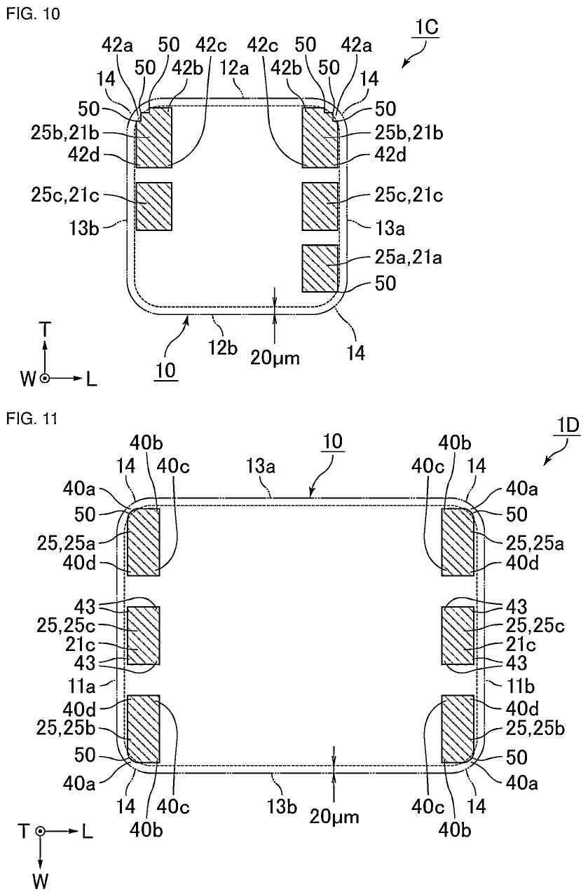

FIG. 9 is a schematic sectional view illustrating an example of a section of the inductor component illustrated in FIG. 8 along the line segment a1-a2. FIG. 10 is a schematic sectional view illustrating an example of a section of the inductor component illustrated in FIG. 9 along the line segment b1-b2. FIGS. 9 and 10 each illustrate a vertical section. More specifically, FIG. 9 illustrates a vertical section of the inductor component 1C illustrated in FIG. 8 along the length direction L and the height direction T, that is, a vertical section including the first coil wire 21a, the second coil wire 21b, and the third coil wire 21c in the LT plane. FIG. 10 illustrates a vertical section of the inductor component 1C illustrated in FIG. 8 along the width direction W and the height direction T, that is, a vertical section including the first coil wire 21a, the second coil wire 21b, and the third coil wire 21c in the WT plane.

In addition, the broken line in FIGS. 9 and 10 indicates a position offset from the outer shape of the element body 10 by 20 μm.

As illustrated in FIGS. 9 and 10, as in Embodiments 1 and 2, in the vertical section, in the second inner wire 25b located at the other end in the direction parallel to the coil axial direction, especially the second coil wire 21b, the shape of the corner 42a adjacent to the corner portion 14 of the element body 10 is different from the shapes of the remaining three corners 42b to 42d.

On the other hand, in the vertical section, the first inner wire 25a located at one end in the direction parallel to the coil axial direction, particularly the first coil wire 21a, does not have a notch shape, a stepped shape, or a curved shape, which will be described later.

In addition, in the present embodiment, the corner 42a of the second inner wire 25b adjacent to the corner portion 14 of the element body 10 has a stepped shape. Therefore, compared to a notch shape, the sectional area of the inner wire 25 located at the end can be increased, and therefore Rdc can be further reduced. Therefore, it is possible to further improve the Q value of the inductor component 1A, particularly the Q value at low frequencies.

Here, as illustrated in FIGS. 9 and 10, “stepped shape” means a stepped shape with two or more steps, and does not include a stepped shape with one step.

In the example illustrated in FIGS. 9 and 10, the stepped shape of the corner 42a has two steps but may have three or more steps.

Also in the present embodiment, as in Embodiment 1, in the vertical section, the corner 40a of the inner wire 25 located at the end, adjacent to the corner portion 14 of the element body 10, preferably has at least one corner portion 50, and more preferably has at least two corner portions 50 whose distance d from the corner portion 14 of the element body 10 is equal to or less than the side gap of the product or equal to or less than 20 μm (see FIGS. 9 and 10).

In the example illustrated in FIG. 9, in the vertical section (LT plane), there are the corner portions 50 of the inner wires 25 whose distance from the corner portion 14 of the element body 10 is equal to or less than 20 μm at 3 locations×2 corners+1 location (7 locations in total).

In the example illustrated in FIG. 10, in the vertical section (WT plane), there are the corner portions 50 of the inner wires 25 whose distance from the corner portion 14 of the element body 10 is equal to or less than 20 μm at 3 locations×2 corners+1 location (7 locations in total).

### Embodiment 4

In the inductor component of Embodiment 4 of the present disclosure, the inner wire located at either end in the direction parallel to the coil axial direction has a curved shape of the corner adjacent to a corner portion of the element body in the vertical section. The inductor component according to Embodiment 4 of the present disclosure is the same as the inductor component according to Embodiment 2 of the present disclosure except for this point.

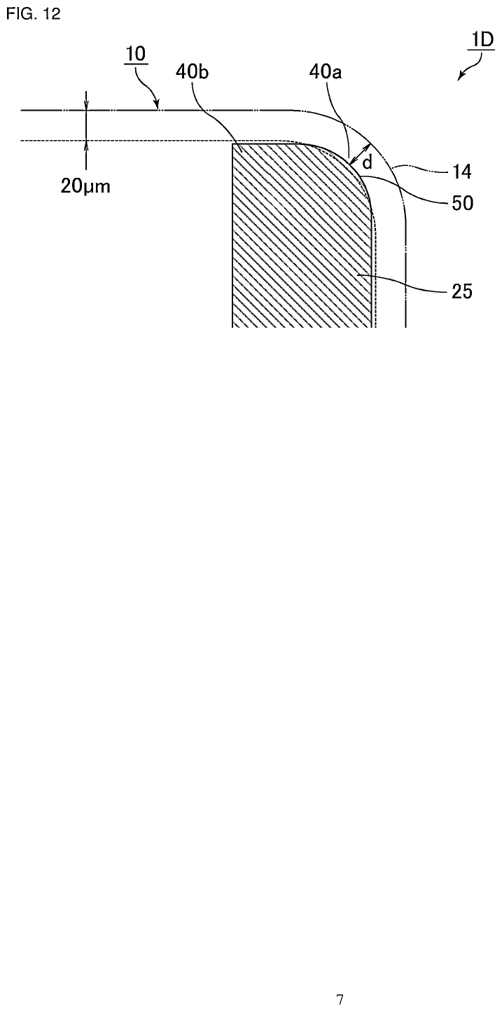

FIG. 11 is a schematic sectional view illustrating an example of an inductor component according to Embodiment 4 of the present disclosure. FIG. 11 corresponds to a section of the inductor component illustrated in FIG. 5 along the line segment a1-a2. That is, FIG. 11 illustrates a vertical section. More specifically, FIG. 11 illustrates a vertical section of the inductor component along the length direction L and the width direction W, that is, a vertical section including the first coil wire, the second coil wire, and the third coil wire in the LW plane.

In the inductor component 1D illustrated in FIG. 11, as in Embodiments 1 to 3, in the inner wire 25 located at either end in the direction parallel to the coil axial direction, the shape of the corner 40a adjacent to the corner portion 14 of the element body 10 is different from the shapes of the remaining three corners 40b to 40d in the vertical section.

On the other hand, in the present embodiment, the shape of the corner 40a adjacent to the corner portion 14 of the element body 10 is a curved shape. Therefore, compared to a notch shape or a stepped shape, the sectional area of the inner wire 25 located at the end can be increased, and therefore Rdc can be further reduced. Therefore, it is possible to further improve the Q value of the inductor component 1A, particularly the Q value at low frequencies.

FIG. 12 is a schematic sectional view illustrating an example of a corner portion of an element body and the vicinity thereof in the inductor component illustrated in FIG. 11. In FIGS. 11 and 12, the broken line indicates a position offset from the outer shape of the element body 10 by 20 μm.

Also in the present embodiment, as in Embodiment 1, in the vertical section, the corner 40a of the inner wire 25 located at the end, adjacent to the corner portion 14 of the element body 10, preferably has at least one corner portion 50, and more preferably has at least two corner portions 50 whose distance d from the corner portion 14 of the element body 10 (see FIG. 12) is equal to or less than the side gap of the product or equal to or less than 20 μm (see FIGS. 11 and 12).

In the example illustrated in FIG. 11, in the vertical section (LW plane), there are the corner portions 50 of the inner wires 25 whose distance from the corner portion 14 of the element body 10 is equal to or less than 20 μm at 1 location×4 corners (4 locations in total).

The inductor component 1D is manufactured by, for example, a photolithography method in the same manner as in Embodiment 1.

In the present embodiment, in the patterning of the conductor layer, by forming (laminating) a plurality of conductor patterns in multiple stages while gradually changing the outer shape of the patterns, the corner 40c of the inner wire 25 located at the end in the vertical section can be formed into a curved shape.

In Embodiments 2 to 4 described above, a case where the number of the laminated layers of the inner wires is 3 has been described, but in the inductor component according to the present disclosure, the number of the laminated layers of the inner wires may be 4 or more. In that case, all the inner wires other than the inner wires located at respective ends in a direction parallel to the coil axial direction have preferably none of a notch shape, a stepped shape, and a curved shape in a vertical section, and the four corners have preferably the same shape (for example, a right-angled shape).

The following contents are disclosed in this specification.

<1> An inductor component includes: an element body having a rectangular parallelepiped shape and including a pair of end surfaces facing each other in a length direction, a top surface and a bottom surface facing each other in a height direction, and a pair of side surfaces facing each other in a width direction; an inner wire provided inside the element body and including a coil spirally wound along a coil axial direction; a first outer electrode electrically connected to one end portion of the inner wire and provided on one of the pair of end surfaces; and a second outer electrode electrically connected to another end portion of the inner wire and provided on another of the pair of end surfaces. In a section parallel to the coil axial direction and orthogonal to a direction in which the inner wire extends, the inner wire has four corners, and a part of the inner wire located at either end in a direction parallel to the coil axial direction includes one of the four corners that is adjacent to a corner portion of the element body and has a shape different from shapes of remaining three corners.

<2> The inductor component according to <1>, in which, in the section, the shape of the corner adjacent to the corner portion of the element body is a notch shape, a stepped shape, or a curved shape.

<3> The inductor component according to <1> or <2>, in which the inner wire includes a first inner wire located at one end, a second inner wire located at another end, and a third inner wire located between the first inner wire and the second inner wire in the direction parallel to the coil axial direction. Also, in the section, a shape of a corner that is adjacent to a corner portion of the element body in the third inner wire includes none of a notch shape, a stepped shape, and a curved shape.

<4> The inductor component according to any one of <1> to <3>, in which, in the section, the corner adjacent to the corner portion of the element body has at least one corner portion whose distance from the corner portion of the element body is equal to or less than a side gap of a product or equal to or less than 20 μm.

<5> The inductor component according to <4>, in which, in the section, the corner adjacent to the corner portion of the element body has, for each corner portion of the element body, at least two corner portions whose distance from the corner portion of the element body is equal to or less than a side gap of the product or equal to or less than 20 μm.

What is claimed is:

1. An inductor component comprising:
an element body having a rectangular parallelepiped shape and including a pair of end surfaces facing each other in a length direction, a top surface and a bottom surface facing each other in a height direction, and a pair of side surfaces facing each other in a width direction;
an inner wire inside the element body and including a coil spirally wound along a coil axial direction;
a first outer electrode on one of the pair of end surfaces and electrically connected to one end portion of the inner wire; and
a second outer electrode on another of the pair of end surfaces and electrically connected to another end portion of the inner wire, wherein
the inner wire has four corners in a cross section parallel to the coil axial direction and orthogonal to a direction in which the inner wire extends, and at the inner wire located at one of opposite ends of the element in a direction parallel to the coil axial direction, a shape of one of the four corners which is adjacent to a corner portion of the element body is different from shapes of remaining three corners.

2. The inductor component according to claim 1, wherein
in the section, the shape of the one of the four corners adjacent to the corner portion of the element body is a notch shape, a stepped shape, or a curved shape.

3. The inductor component according to claim 1, wherein
the inner wire includes a first inner wire located at one end, a second inner wire located at another end, and a third inner wire located between the first inner wire and the second inner wire, in the direction parallel to the coil axial direction, and
in the section, a shape of a corner of the third inner wire that is adjacent to a corner portion of the element body is absent a notch shape, a stepped shape, and a curved shape.

4. The inductor component according to claim 1, wherein
in the section, the one of the four corners adjacent to the corner portion of the element body has at least one corner portion whose distance from the corner portion of the element body is equal to or less than a side gap of a product or equal to or less than 20 μm.

5. The inductor component according to claim 4, wherein
in the section, the one of the four corners adjacent to the corner portion of the element body has, for each corner portion of the element body, at least two corner portions whose distance from the corner portion of the element body is equal to or less than a side gap of the product or equal to or less than 20 μm.

6. The inductor component according to claim 2, wherein
the inner wire includes a first inner wire located at one end, a second inner wire located at another end, and a third inner wire located between the first inner wire and the second inner wire, in the direction parallel to the coil axial direction, and
in the section, a shape of a corner of the third inner wire that is adjacent to a corner portion of the element body is absent a notch shape, a stepped shape, and a curved shape.

7. The inductor component according to claim 2, wherein
in the section, the one of the four corners adjacent to the corner portion of the element body has at least one corner portion whose distance from the corner portion of the element body is equal to or less than a side gap of a product or equal to or less than 20 μm.

8. The inductor component according to claim 7, wherein
in the section, the one of the four corners adjacent to the corner portion of the element body has, for each corner portion of the element body, at least two corner portions whose distance from the corner portion of the element body is equal to or less than a side gap of the product or equal to or less than 20 μm.
